(19) United States
(12) Patent Application Publication
(10) Pub. No.: US 2013/0066712 A1
(43) Pub. Date: Mar. 14, 2013

(54) METHOD AND SYSTEM FOR SERVING ADVERTISEMENTS BASED ON VISIBILITY OF AD-FRAMES

(71) Applicant: Dennoo Inc., Palo Alto, CA (US)

(72) Inventor: Shigeto Umeda, Palo Alto, CA (US)

(73) Assignee: DENNOO INC., Palo Alto, CA (US)

(21) Appl. No.: 13/653,394

(22) Filed: Oct. 16, 2012

Related U.S. Application Data
(63) Continuation-in-part of application No. 13/570,831, filed on Aug. 9, 2012.
Application No. 13/570,831 is a continuation-in-part of application No. 13/477,981, filed on May 22, 2012.
Application No. 13/477,981 is a continuation-in-part of application No. 13/324,325, filed on Dec. 13, 2011.
Application No. 13/570,831 is a continuation-in-part of application No. 13/478,020, filed on May 22, 2012.
Application No. 13/478,020 is a continuation-in-part of application No. 13/324,325, filed on Dec. 13, 2011.
Application No. 13/570,831 is a continuation-in-part of application No. 13/540,528, filed on Jul. 2, 2012.
Application No. 13/540,528 is a continuation-in-part of application No. 13/324,325, filed on Dec. 13, 2011.
Application No. 13/324,325 is a continuation-in-part of application No. 13/477,981, filed on May 22, 2012.
Application No. 13/570,831 is a continuation-in-part of application No. 13/540,538, filed on Jul. 2, 2012.
Application No. 13/540,538 is a continuation-in-part of application No. 13/605,915, filed on Sep. 6, 2012.
Application No. 13/605,915 is a continuation-in-part of application No. 13/324,325, filed on Dec. 13, 2011.
Application No. 13/324,325 is a continuation-in-part of application No. 13/477,981, filed on May 22, 2012.
Application No. 13/477,981 is a continuation-in-part of application No. 13/478,020, filed on May 22, 2012.
Application No. 13/478,020 is a continuation-in-part of application No. 13/540,528, filed on Jul. 2, 2012.
Application No. 13/540,528 is a continuation-in-part of application No. 13/540,538, filed on Jul. 2, 2012.
Application No. 13/540,538 is a continuation-in-part of application No. 13/570,831, filed on Aug. 9, 2012.
(60) Provisional application No. 61/540,164, filed on Sep. 28, 2011.
(60) Provisional application No. 61/568,594, filed on Dec. 8, 2011.
(60) Provisional application No. 61/600,380, filed on Feb. 17, 2012.
(60) Provisional application No. 61/615,834, filed on Mar. 26, 2012.
(60) Provisional application No. 61/635,819, filed on Apr. 19, 2012.
(60) Provisional application No. 61/600,380, filed on Feb. 17, 2012.
(60) Provisional application No. 61/615,834, filed on Mar. 26, 2012.
(60) Provisional application No. 61/635,819, filed on Apr. 19, 2012.

(30) Foreign Application Priority Data
Sep. 9, 2011 (JP) 2011-197718

(51) Int. Cl. G06Q 30/02

(52) U.S. Cl. 705/14.45; 705/14.71; 705/14.68

(57) ABSTRACT

Introduced is a method for presenting online advertisements based on a visibility of an advertisement (ad) spot in online content. The method includes determining ad spots that are visible or at least a substantial portion of the ad spots that are visible for a pre-defined duration, and serving advertisements in those ad spots. The method includes auctioning only the selected ad spots to the advertisers. Another method for measuring effectiveness of an ad creative is disclosed. The effectiveness of an ad creative is measured using a metric, such as an engagement rate of the ad creative. The engagement rate is determined as a ratio of a number of users that responded to the ad creative to a total number of users to whom the ad creative was served, wherein number of users who responded to the ad creative is a function of response score of the ad creative.

### CLAIM OF PRIORITY

This application claims the benefit of Japanese Patent Application No. 2011-197718, filed Sep. 9, 2011; U.S. Provisional Application Ser. Nos. 61/540,164, filed Sep. 28, 2011; 61/568,594, filed Dec. 8, 2011; 61/600,380, filed Feb. 17, 2012; 61/615,834, filed Mar. 26, 2012; and 61/635,819, filed Apr. 19, 2012, and is a Continuation-in-Part of U.S. patent application Ser. No. 13/324,325 filed on Dec. 13, 2011; U.S. patent application Ser. No. 13/477,981 filed on May 22, 2012; U.S. patent application Ser. No. 13/478,020 filed on May 22, 2012; U.S. patent application Ser. No. 13/540,528 filed on Jul. 2, 2012; U.S. patent application Ser. No. 13/540,538 filed on Jul. 2, 2012; U.S. patent application Ser. No. 13/570,831 filed on Aug. 9, 2012; U.S. patent application Ser. No. 13/605,915 filed on Sep. 6, 2012, and is related to co-pending United States Provisional Application No. 61/699,143 filed on Sep. 10, 2012; and U.S. Provisional Application No. 61/708,560 filed on Oct. 1, 2012, all of which are incorporated herein by reference for all purposes in their entirety.

### FIELD

The present invention generally relates to methods and systems for processing and displaying advertisements. Such processing and displaying an advertisement may include, for example, determining ad spots that are visible or at least a substantial portion of the ad spots that are visible for a pre-defined duration, and serving advertisements in those ad spots.

### BACKGROUND

Advertising in the field of e-commerce comprises several different types and modes of advertising, such as, for example, search based advertising, branding advertising, etc. One of two main types of advertising mechanisms or e-commerce based advertisements is the “Direct Response Advertisement,” such as Cost-Per-Click (CPC) in which cost accrues for clicks, or Cost-per-Action (CPA) in which cost accrues in the event of a particular action or conversion. The other major type of e-commerce based advertisement is “branding advertisement” in which cost accrues not based on clicks, actions or effectiveness, but based on the number of “impressions,” usually in lots of one thousand impressions, or Cost-per-Mille (CPM). An online advertisement impression is a single appearance of an advertisement on a web page. Each time an advertisement loads onto a user's screen, the ad server may count that loading as one impression.

Typically, advertisements are purchased and sold on cost per impression basis, regardless on which ad spot/slot/frame the advertisements are displayed to the end user. However, not all ad spots deliver the same impact or effect on advertisement. Some of the ad spots may not even be in the visible area of the web page. For example, an ad spot may be in bottom of the web page, which is outside the initial viewable area and is visible only when the user scrolls down to the bottom of the web page. Such ad impressions may not be effective since the ads may not even be viewed by the users. However, the advertisers are still charged for the impressions delivered. Accordingly, not all the ad impressions return the same return on investment (ROI).

Further, in the world of internet and e-commerce, advertisements may be displayed to the users over and over regardless of whether or not the user feels that an advertisement is interesting, relevant and engaging to them. That is, current advertising systems deliver ads regardless of whether or not they are effective. Such techniques do not fetch a good ROI for the advertiser.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 provides a brief, general description of a representative environment in which the invention can be implemented;

FIG. 2 is a block diagram illustrating an exemplary architecture of a platform server;

FIG. 3 provides a brief, general description of a representative environment in which a second embodiment of the invention can be implemented;

FIG. 4 is a block diagram illustrating a system for presenting advertisement spots to an auction;

FIG. 5 is a flow diagram of a process for presenting ad spots to an auction;

FIG. 6 is a flow diagram of a process for measuring effectiveness of an ad creative;

FIG. 7 is a high-level block diagram showing an example of the architecture for a computer system;

The headings provided herein are for convenience only and do not necessarily affect the scope or meaning of the claimed invention.

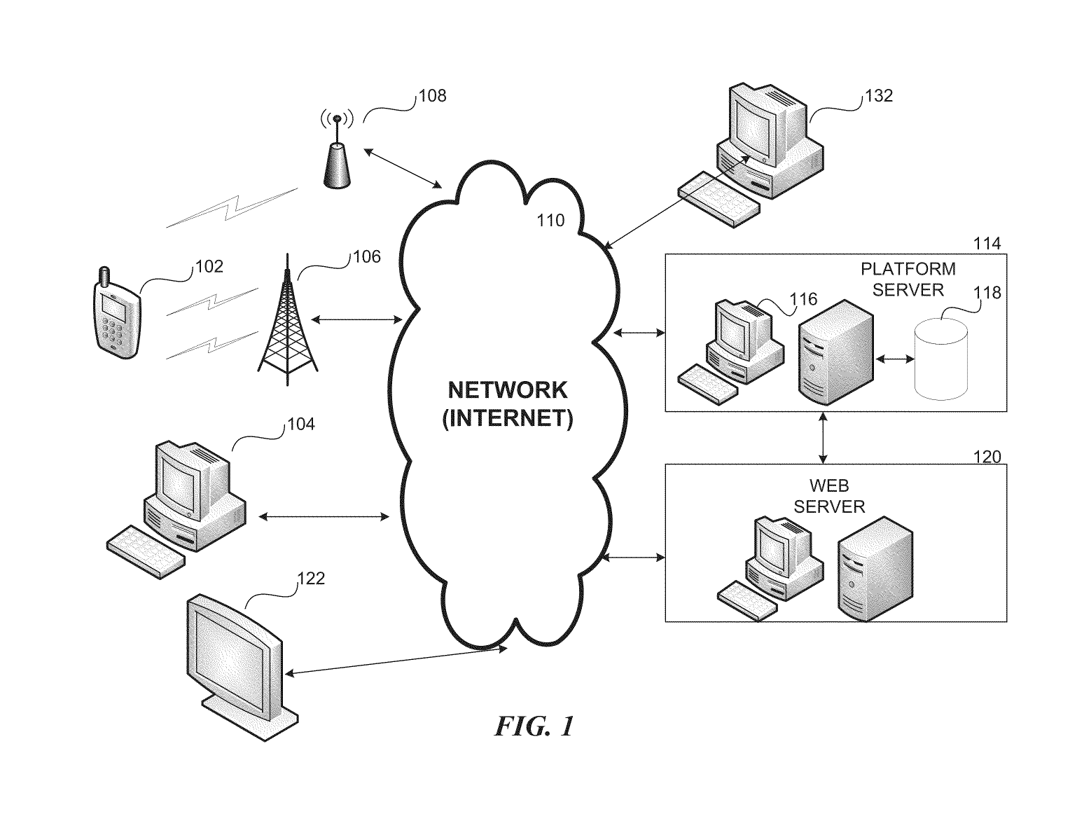

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 114 is first introduced and discussed with respect to FIG. 1).

### SUMMARY OF THE DESCRIPTION

The invention relates to processing and presenting a plurality of advertisements online based on a visibility of an advertisement spot (also referred to as “ad spot,” “ad slot,” or “ad frame”). An ad spot is any space available, for example, in online media, for presenting an advertisement. In an embodiment, the ad spot may be provided on a web page of a web site. In a first aspect, a method for auctioning only the ad spots that are visible, or at least a substantial portion of the ad spots those are visible to a user for pre-defined duration. The method includes embedding a tag in the web page of the ad spots that determines data regarding visibility and the duration of the visibility of the ad spot, and sends the data to a platform server.

In another aspect, a method for determining a metric to measure an effectiveness of an ad creative is disclosed. A metric, such as engagement rate, is determined as a ratio of a number of users that responded to the ad creative to a total number of users to whom the ad creative was served. The number of users who responded to the ad creative may be determined as a function of response score of a user action. The response score indicates a degree of the user action performed on the ad creative. The user action includes at least one of (a) rewinding the ad impression, (b) altering audio volume of the advertisement impression, or (c) hovering a cursor of a pointing device over the advertisement impression.

Implementations can include any, all or none of the following features. Other advantages and features will become apparent from the following description and claims. It should be understood that the description and specific examples are intended for purposes of illustration only and not intended to limit the scope of the present disclosure.

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

FIG. 1 and the following discussion provide a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

As shown in FIG. 1, a user may use a personal computing device (e.g., a phone 102, a personal computer 104, etc.) to communicate with a network and/or view displays communicated via the network 110. The term “phone,” as used herein, may be a cell phone, a personal digital assistant (PDA), a portable email device (e.g., a Blackberry®), a portable media player (e.g., an IPod Touch®), or any other device having communication capability to connect to the network. In one example, the phone 102 connects using one or more cellular transceivers or base station antennas 106 (in cellular implementations), access points, terminal adapters, routers or modems 108 (in IP-based telecommunications implementations), or combinations of the foregoing (in converged network embodiments). In some instances, one or more users may also use an electronic display 132 (e.g., an electronic overhead display, an electronic billboard display, etc.) to view information communicated via the network. In the context of this description, information communicated may include, for example, advertisements displayed either by themselves or advertisements displayed in conjunction with web pages or other online media a user may be watching/experiencing. Concepts behind display of such advertisements will be explained in further detail in the following sections.

In some instances, the network 110 is the Internet, allowing the phone 102 (with, for example, WiFi capability), the personal computer 104, or the electronic display 122 to access content offered via various servers (e.g., web server 120) connected via the network. In some instances, especially where the phone 102 is used to access web content through the network 110 (e.g., when a 3G or an LTE service of the phone 102 is used to connect to the network 110), the network 110 may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

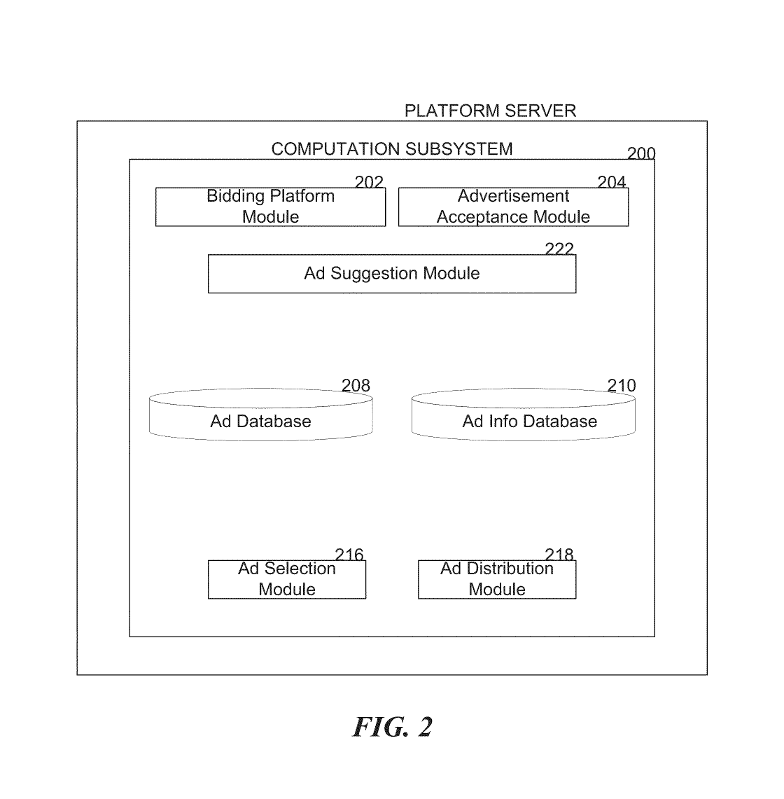

In some instances, a user uses one of the computing devices (e.g., the phone 102, the personal computer 104, etc.) to connect to an platform server 114 through the network 110. In one embodiment, the platform server 114 comprises a server computer 116 coupled to a local database 118. The term “platform server” as indicated herein, refers to an individual or multiple server stations or other computing apparatus. In one embodiment, the platform server is a web server capable of hosting a website and storing content (e.g., various webpages) that is associated with the website. In some embodiments, the platform server is separate from a web server, but communicates with a web server to provide, manage, and/or control content generated by the web server. In general, the platform server 114 includes various modules (either implemented as software or in hardware) that allow for advertising information to be collected from advertisers wishing to strategically engage in an advertising campaign, and to coordinate and relay ensuing advertisements to end systems. In embodiments, the platform server may independently coordinate the processing and eventual display of advertisements. In embodiments, as will be explained in the example of FIG. 2, the platform server may offer interfaces (e.g., APIs) to existing advertising network platforms to coordinate one or more specific advertising activities (e.g., providing abilities for bidding, providing campaign conversion modules, etc.) as will be explained in further detail below. As will also be explained in further detail herein, the administration server 114 incorporates one or more functional units to achieve each of the above discussed functionalities.

As shown in FIG. 1, in some embodiments, the personal computing devices and the administration server 114 are connected through the network 110 to one or more web servers (e.g., web server 120). Each web server corresponds to a computing station that enables a website provider, for example, to provide web content (e.g., web pages) that can be accessed by the personal computing devices through the network 110.

An platform server, as defined herein, could be a separate server offering the service described herein to, for example, one or more website providers. In other examples, the administration server could by itself be a website provider that also runs a service that accomplishes the techniques described herein. Additional examples of implementing an administration server, as understood by a person of ordinary skill in the art, are equally suitable for implementing the techniques described herein.

In the context of the systems described herein, in one embodiment, the platform server is implemented as a search system that enables advertisement display measures, allowing one or more advertisements to be shown either simultaneously or at various discrete timings based on advertisement data obtained through the network (e.g., from an advertising client 132). The platform server 114 may then communicate the advertisement to an advertisement display system (e.g., the user's personal computing device) in which the individual advertisements are shown for a predetermined length of time or according to variables established by the advertising client.

Consider an exemplary scenario where distinct advertisements x1, x2, x3, . . . xp are to be shown to the user as processed and output by the platform server 114. These advertisements are predetermined to be displayed for lengths of t1, t2, t3, . . . tp. However, this does mean that that the advertisement to be shown is also predetermined. For example, if a user browses and views the internet using a PC, various advertisements may be shown for various situations, and the techniques described herein includes the case in which these advertisements are shown and sustained for a predetermined length of time.

An advertisement, as described herein, includes without limitation movies, still images, banners, animated pictures, etc. As processed by the platform server, such advertisements are shown for a period and such periods may be predetermined, for example, by the advertiser. In cases where the advertisement is a movie, either the length of the prepared movie or the play time designated by the advertiser will be the display time for the advertisement. In cases where the advertisement is a still image, the display time will be the time designated by the advertiser.

The “display” of an advertisement refers to display of an advertisement that can be substantial or meaningful. For example, on a web screen, if the user scrolls down on the screen, it is preferable that the advertisement scrolls alongside to fit the screen on which it is displayed. However, if the above method is not possible and the user scrolls the screen to the extent that the advertisement is no longer visible on the screen displayed, the advertisement should be stopped, and the time that the advertisement had been played should be recorded (at least for the purpose of computing cost per second of display of the advertisement, as will be explained further below). When the advertisement returns to display on the screen, the advertisement should be resumed, and the total playing time will be recorded at the end of the advertisement or at the time of the next stop. The judgment of “whether the advertisement is displayed or not” can, for example, be that if a certain proportion of the advertisement is not shown within the screen, the advertisement can be considered to be “not displayed on the screen”. Here, a “certain proportion” can refer to a proportion at which substantial viewing of the advertisement can be deemed to be difficult, for example at a proportion of 50% or more. However, more than 50% is merely an example, and the proportion need not be limited to 50% or more. For example, the advertisement display can be divided into a major portion (e.g. the portion where the product or service name to be advertised is shown) and a minor portion, and when the major portion is shown on the screen, it may be judged that the advertisement is displayed on the screen.

The techniques discussed herein include a bidding system that allows an advertiser to place a bid for a certain spot and duration of advertisement. As illustrated with respect to FIG. 2, the platform server 114, in some embodiments, may include a bidding platform module 202 to enable the bidding operations. In the way of an example, the bidding platform module may present an appropriate GUI to the advertising client 132 to enable the advertiser to make appropriate selections and provide input. These are then taken in by the bidding platform module 202 for further processing and assessing for bidding.

In situations where the advertiser is aware of the display length beforehand, in embodiments, the advertiser may use bidding as the method of advertisement display time sales (“purchase” from the advertisers' perspective) in order to determine the order of precedence when displaying the advertisement(s). In other words, the amount of advertisement that can be displayed within an advertising space is generally finite. In addition, for web screens, if there is more than one advertisement that can be shown on the same advertisement space, the order in which the advertisements are placed becomes important. Specifically, when displaying advertisements on a specific advertisement space or for specific keywords, an input is made (e.g., in the form of a bid) for the maximum cost/price that the advertiser can bear for that particular combination of duration and order. It is evident that the order or precedence will be higher when this cost/price is higher.

### Cost per Second (CPS) Based Technology

In at least some embodiments as disclosed herein, the length of time that an advertisement will be shown will vary not only according to the advertisement itself, but also according to secondary factors (e.g., keywords, search relevance, etc.). For example, when publishing an advertisement on a search result page, conventionally, bids are placed for a certain keyword A, and the advertisement to be displayed with higher priority is determined and fixed according to this price. On the other hand, for this invention, comparisons are not made according to the price per display (or impression) of an advertisement, but by the bid on the price per unit of time, or Cost per Second (CPS). Bids can be placed directly through CPS, or the cost per advertisement can be used as the unit of bid, and divided by the number of seconds of advertisement display in order to calculate the CPS to compare prices between various advertisements.

For example, assume that there exist two advertisement spaces (F1 and F2) on a search result page for a certain keyword A, and that the advertisement effect of advertisement space F1 excels that of advertisement space F2. If advertiser D1 bids for price P1, advertiser D2 bids for price P2, advertiser D3 bids for price P3 and P1>P2>P3, conventionally, advertiser D1 won advertisement space F1, advertiser D2 won advertisement space F2 and advertiser D3 could not win an advertisement space. As a result, the publisher/media can only utilize two advertisement spaces (and lose revenue from advertiser D3), and advertiser D3 would lose the opportunity to advertise.

However, using technology introduced herein, for example, the publisher/media can sell the two advertisement spaces (F1 and F2) separately at the time of the bid. For example, for advertisement space F1, advertiser D1 bids for a CPS price P1, advertiser D2 bids for a CPS price P2, advertiser D3 bids for a CPS price P3 and P1>P2>P3, the advertisement display time for F1 can be sold to advertiser D1, advertiser D2 and advertiser D3 in the respective order.

Additionally, if the total time that the advertisements are played for each advertisers D1, D2 and D3 are T1, T2 and T3, respectively, in simple terms, the publisher/media receives an advertising revenue of P1×T1+P2×T2+P3×T3 (in reality, if the displayable time exceeds T1+T2+T3, the order of priority will be determined as D1>D2>D3. Additionally, the order of priority can be changed according to other factors such as the time in the day, etc.). As a result, the publisher/media can utilize their advertisement space with higher efficiency, and each advertiser will be able to display advertisements with higher efficacy. In other words, if each advertisers' advertisement (assuming that each had one type of advertisement) has a display length of t1, t2 and t3 per advertisement, each advertiser will be able to publish T1/t1, T2/t2 and T3/t3 advertisements respectively (assuming that there is no upper limit to the display time). For the user, the amount of information received would be greater than the conventional cases in which one advertisement is shown repeatedly. However, it should be noted that the above example is a highly simplified version. Alternately, a better system may be one that incorporates a display method in which the price determination method is consistent with that in the conventional market.

As offered by the CPS technology introduced herein, the advertisement billing is based on CPS×Seconds Displayed. In embodiments, the cost charged to the advertiser is based on the actual display time. This is because the purchase of the advertisement space is not for an entire unit based of a single display, but for the price/cost per second of an advertisement that will be shown only for a certain time length. The “actual display time” should ideally be the “time that the user is actually watching.” The actual display time may be measured using techniques as understood by people of ordinary skill in the art at the time of this application. However, in systems where constraints are present due to, for example, cost and facilities, the realistic time measurement used can be the “time that the advertisement is shown on the screen”. In other words, the advertisement display time will be measured as the “period in which the advertisement is displayed on the screen”.

Accordingly, in embodiments, advertisements are shown for a certain periods of time. In other words, the advertisements displayed will have a designated order or priority, and more than one advertisement may be shown continuously in a loop. The order, precedence, and length of running such advertisements may be based on a variety of factors. Such factors may be accounted for, for example, through the bidding platform offered in conjunction with the platform server. An example of such a factor may be an order of priority (e.g. time of the day). When such a factor is introduced, it is not known under which conditions the advertisement should be displayed for higher effectiveness. One way to overcome this issue would be to play the advertisements in varying orders with equal likeliness. When this is the case, a statistically significant sample size will be chosen, and various orders will be tested for this sample. The index when evaluating the effectiveness can be, for example, Seconds per Click (SPC), or the number of seconds necessary until the user clicks the advertisement. Analyzing that information over, for example, the time of day such events occur, statistical information may be collected to determine order of priority and corresponding bid value for placing advertisements on the web screens. Using these results, the advertisements can be shown in the order of this index.

The explanation illustrated an example of a case in which advertisements are shown on a search result page, but it is understood that the techniques discussed herein may be applied to a variety of other advertisement types as well. For example, the techniques introduced herein include a novel online advertisement concept where direct response advertisement and branding advertisement are both combined (the product of the two is taken). Correspondingly, there are two main types of advertisement sales: (1) the CPS (cost per second) mode of advertisement sales (as discussed above); and (2) the product of CPS and Cost per Click (CPC), which would be CPS×CPC. CPS is the price per second of advertisement display, and CPC is the cost that the advertiser bears when a user clicks on an advertisement while watching an advertisement and jumps to a website designated by the advertiser. In order to determine the order of priority of advertisement display, the prices of advertisements (e.g., as placed in bid values) are compared, but in an exemplary scenario, a value in which both the CPS and the CPC are included may also be considered in assessing relevance and priority of the bidders. As indicated here, N=CPS×CPC may be a simple case for accounting the CPS and CPC elements jointly, but it is understood that other conversion formulas where the two elements may be effectively considered may also be used.

In embodiments, the platform server 114 includes logic for the purposes of determination of the two types of cost determination and to identify targets and correlation between the two types. In embodiments, and as illustrated in FIG. 2, the platform server may include one or more of the following modules, each being implemented either in hardware, software, or firmware, or a combination thereof: an advertisement (or ad) suggestion module 222 to make determinations and provide according suggestions as to the type, content, duration, etc. of advertisements to be placed on various publishers' sites. The logic incorporated in this module may include, for example, algorithms to identify significance, meaning, context, relevance, etc. of a particular website and accordingly identify relevant advertisements. Further, the platform server 114 may include an advertisement accepting means 204 for accepting advertisements uploaded by advertising clients 132. In embodiments, the platform server 114 may also include advertisement memory 208 for storing advertisements received from advertisers and advertisement information memory 210 for storing information related to advertisements (e.g., relevance information, order or priority information, etc.). In some instances, the modules may further include an ad selection module 216 and an ad distribution module 218 that are configured respectively to select an appropriate ad and to transmit the ad to a predetermined web screen based on determinations made by the platform server.

In embodiments, these include means that are accessible online by the advertiser. Each component/module identified above may be implemented as discrete software or hardware units or a combination thereof. In embodiments, for example, the advertisement space suggestion module to suggest advertisements for publishing on advertisements spaces and the advertisement bidding means can be combined into or be coupled to a web server 120. In embodiments, the structure of the platform may include, for example (in the case of displaying advertisements in a search result page), a GUI to suggest a page in which the keywords used for the search, the various attributes of the user to which the advertisement is desired to be displayed (gender, age, region, profession, educational background, hobbies, etc), the preferred time of the day to display the advertisement can be entered, etc. According to these entered inputs, the price per unit of time for purchasing the advertisement space and the entry field for purchasing the advertisement space (or an entry page) will be then be displayed. For the suggested advertisement space, the advertiser inputs (e.g., through the bidding platform) the desired price per unit of time to purchase the advertisement space, and the number of advertisement spaces to purchase. However, in embodiments, the purchasing of advertisement space can be for the total length of time that the advertisement will be displayed.

In embodiments, the advertisement information memory 210 and the advertisement data memory 212 to store the advertisement itself may include, for example, advertisement information database means to store information related to the advertisement and an advertisement data database means respectively to store the advertisement itself.

Returning back to the illustration of FIG. 1, the process of utilizing the platform server to process and display advertisements is now explained with respect to two scenarios: (1) when the advertisement is returned to a user viewing the advertisement in a web screen; (2) when the advertisement is displayed to multiple users over an electronic display instrument (e.g., an electronic bill board).

As illustrated in FIG. 1, when the advertiser accesses the bidding platform module of the platform server 114, the system, for example, suggests an entry field for the desired conditions regarding the advertisement display. The advertiser 132 inputs the desired conditions accordingly. In response, the platform server 114 may request entry of an advertisement. The received advertisement and advertisement information is then stored in the advertisement video database and the advertisement information database by the advertisement reception device. In embodiments, the information stored in the advertisement video database and the information stored in the advertisement information database are related and attributed by an advertisement ID that is unique to each advertisement. In embodiments, when the advertisement information is transmitted to a display device, the related information may also be attributed by the advertisement ID.

In the first scenario, the user typically has an advertisement display device that is loaded into the web browser (e.g., a widget within a web page, etc.). At this time, in order to display advertisements that match the user's interests, information regarding the page shown and user IDs are sent to the advertisement selection device of the platform server. An advertisement selection module 216 selects the advertisement(s) to be displayed based on the received information and the advertisement data stored in the advertisement information database. The advertisement selection module 216 selects the advertisements to be shown, and the advertisement ID of the advertisement to be shown will be sent to the advertisement screening device (e.g., the user's computer).

After receiving one or more advertisement IDs from the advertisement selection module 216, the advertisement transmitting or distribution module 218 sends one or more advertisements continuously to the advertisement display device. The advertisement screening device displays the advertisement to the user upon reception. For videos, the display time is generally determined by the length that the video advertisement is played. For still images, the display time is determined by the time designated by the advertiser.

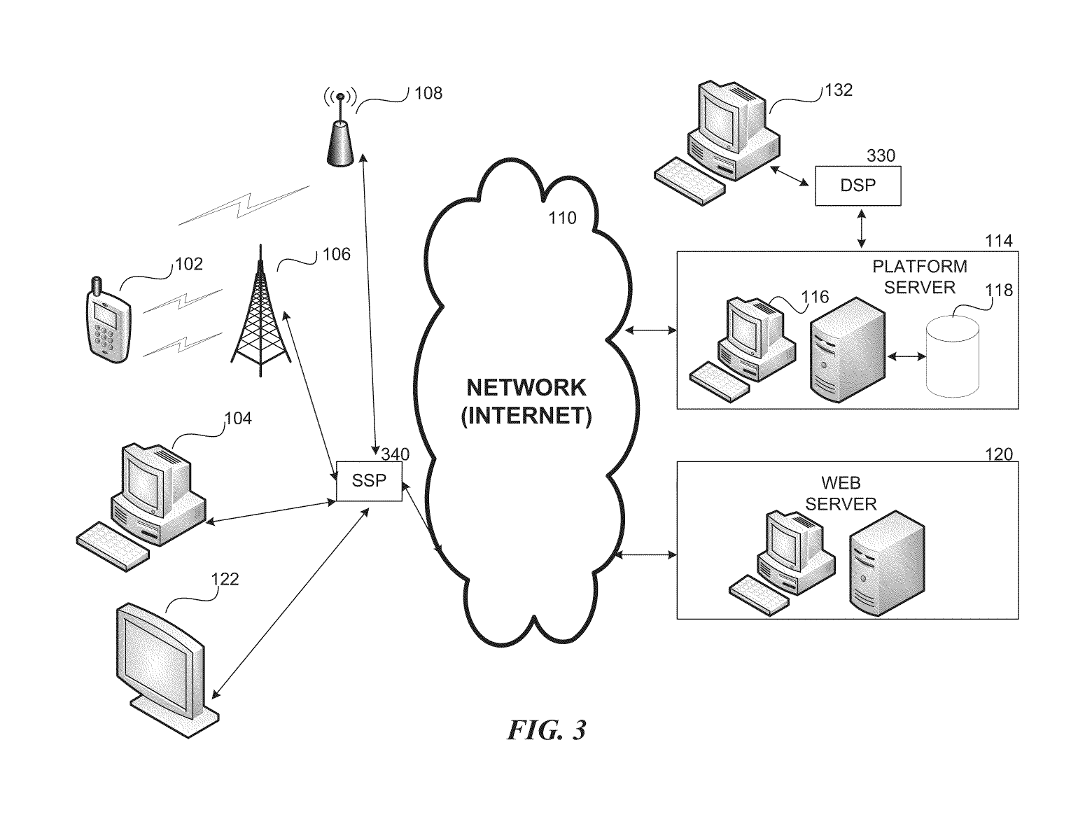

FIG. 3 illustrates the second scenario, where the advertisement display device with which the user watches advertisements is not equipped on the browser, but rather a device that is connected to the internet, such as on an LCD display for street advertising (e.g., device 122). In this scenario, the advertisement display device is not equipped on a web browser, so information as to the basis of selecting the advertisement to display may not exist. In such cases, the advertisement display device does not send out information for advertisement selection, but instead just display the advertisements continuously in a predetermined order. However, for example, if a digital signage device is located in various stores and locations, it is possible that conditions for selecting the advertisement, such as showing it on a device in a ramen noodle store in the shopping quarters from 5 PM to 11 PM, are specified and the advertisements are shown accordingly. In such cases, the advertisement that best matches such conditions may be selected. For videos, the display time is generally determined by the length that the video advertisement is played. For still images, the display time is determined by the time designated by the advertiser

A third scenario of processing and displaying advertisements in accordance with the techniques discussed herein is illustrated with reference to FIG. 3. In this example, the publishing of advertisements and the displaying on the advertisement viewing device are carried out not directly between the advertiser and the user, but by using interfaces to a Demand Side Platform (DSP) 330 and a Supply Side Platform (SSP) 340. The composition of this exemplary embodiment constitutes an advertisement exchange that can incorporate the present teachings with conventional advertising exchanges.

In embodiments, either the DSP, SSP or both may be included. The composition can be either through a connection with the DSP, a composition with a direct connection to the advertiser, or a combination thereof. Similarly, the composition can be either through a connection with the SSP, a composition with a direct connection to the user, or a combination. Other similar combinations of one or more DSPs and SSPs, as may be contemplated by a person of ordinary skill in the art, may also be used as alternate or variants of the above discussed composition.

In this example, when the advertisement is sent by the advertiser, it is stored in the DSP, which acts as the mediator on the advertiser's side. The DSP then selects an advertisement exchange (not shown) from among the advertisement exchanges, and the advertisement is published. In order for the device devised by this invention to receive the advertisement, a bid to determine the price of the advertisement is received from the advertiser through the DSP.

On the other hand, on the user's side, the advertisement is received not directly from the device devised by this advertisement, but from the SSP, and the advertisement is shown. After receiving the advertisement display request from the user, the SSP selects one or more advertisement exchanges to receive advertisements from, and requests for advertisements. At this time, the system (advertisement exchange) devised by this invention, which has received the advertisement request, also receives information necessary to select the advertisement that best matches the user, and according to this information, chooses the best-match advertisement from the displayable advertisements, sending the advertisement to the SSP. After receiving the advertisement, the SSP sends the advertisement to the user, and the user watches the advertisement.

In embodiments, with such a composition, the advertising side can increase the effectiveness of their advertisement by widening the array of media/publishers to display their advertisements on. The results in quantifiable advantages on both sides of the spectrum—on the media/publisher side that will show advertisements, revenue for advertisement spaces increases by allowing for selection from a larger number of advertisements the advertisement that best matches the users' interests. From the users' perspective, for similar reasons, advertisements will be chosen from a greater variety, and the users will be able to watch advertisements that match the users' interests.

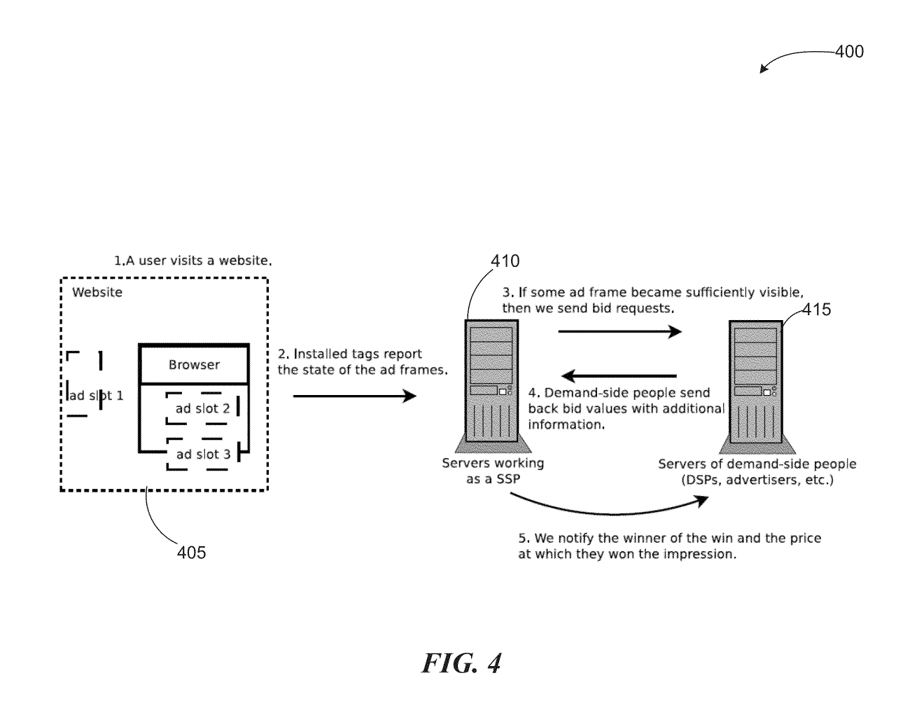

FIG. 4 is a block diagram illustrating a system 400 for presenting ad spots to an auction, according to an embodiment of the disclosed technique. The system 400 includes SSP 410 (similar to SSP 340 of FIG. 3) that identifies the ad spots on a web page 405 and presents them to an auction. The DSP 415 (similar to DSP 330 of FIG. 3), such as advertisers bidding for ad spots, participating in the auction bids for the ad spots. The web page 405 can include any online content that is accessible by a user through, for example, a web browser or any other proprietary applications. The web page 405 includes one or more ad spots and each of the ad spots can render one or more advertisements served by the SSP 410. A user accessing the web page 405 may view the advertisement rendered in the ad spots and perform an action on the advertisements.

The SSP 410 is configured to identify the ad spots that are visible to the user for a predefined duration, and present only those ad spots to the auction. In an embodiment, the SSP 410 identifies those ad spots for which a pre-defined portion of the ad spot, typically a substantial portion, is visible to the user. In an embodiment, the substantial portion could be at least 50% of the ad spot area and pre-defined duration can be at least 100 milliseconds. After the ad spots are determined, the SSP 410 presents the ad spots to the auction and requests the advertisers to place bids for the ad spots. The request may also include a response time indicating a time within which the advertisers have to submit their bids.

The advertisers/DSP 415 submits the bids along with the advertisements to be served in the ad spots, to the SSP 410. After receiving the bids from the advertisers, the SSP 410 determines a winning bid based on predefined criteria, such as second-bid auction process described in U.S. patent application Ser. No. 13/609,146, or any other convenient method. The SSP 410 notifies the advertiser regarding the winning price of the impression. Further, the advertisement of the winning advertiser is served in the ad spot. Accordingly, by serving ads in visible ad spots the chances of an ad not being viewed by a user is reduced.

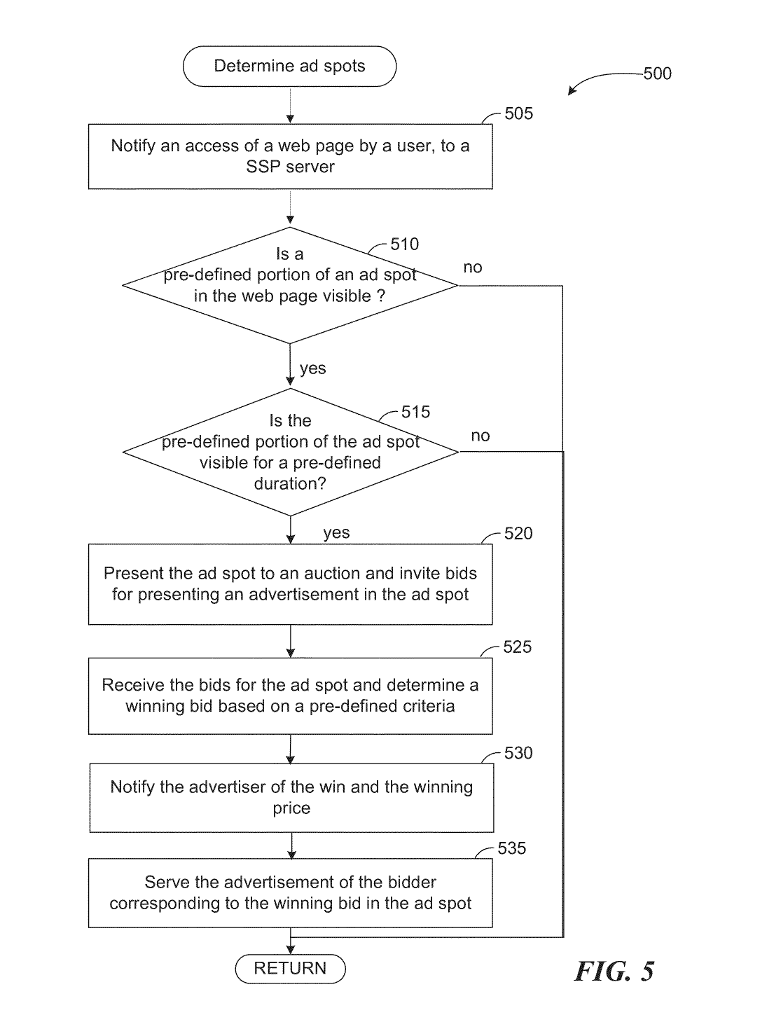

FIG. 5 is a flow diagram of a process 500 for presenting ad spots to an auction, according to an embodiment of the disclosed technique. The process 500 may be executed in a system such as system 400 of FIG. 4. At step 505, SSP is notified of a user's visit to a web page. At determination step 510, the SSP determines whether a pre-defined portion (substantial portion) of an ad spot was visible. Responsive to a determination that the substantial portion of the ad spot was visible, at determination step 515, the SSP determines whether the substantial portion of the ad spot was visible for a predefined duration.

Responsive to a determination that the ad spot was visible for a predefined duration, at step 520, the SSP presents the ad spot to the advertisers/DSP server in auction and invites the advertisers to submit bids for the ad spot. At step 525, the SSP receives the bids from the advertisers and determines a winning bid based on predefined criteria. At step 530, the SSP notifies the advertiser of the win and the winning price. At step 535, the advertisement of the winning advertiser is served in the ad spot.

In an embodiment, the process 500 is executed for all the ad spots in the web page. Referring back to steps 505-515, a tag, such as an HTML tag, is embedded in the web page to capture data regarding the user's visit to the web page, visibility of the ad spots, the duration of visibility, etc. and send the data to the SSP.

Referring back to step 520, when the SSP sends the request to the advertisers to submit bids for the selected ad spots, the SSP also requests that the bids be placed within a pre-defined time limit, t_{b}. The SSP may specify the time limit to the advertisers either by including it in the request or by any other suitable way.

Referring back to step 525, the advertisers respond to the bid request, by submitting bid values along with additional information, such as the ad to be served in the ad spot if an advertiser wins the bid. Referring back to step 530, the winner and the price is determined using a second-bid auction method, or by other suitable methods.

### Measuring Effectiveness of an Advertisement Creative

A user can respond to an ad creative in a number of ways, for example, by rewinding an audio clip or video clip, enabling sound of the ad, pointing a cursor of a pointing device to a particular portion of the ad, clicking the ad, saving the ad, forwarding the ad via email to other users, sharing the ad with other users, etc. In an embodiment, an ad on which a user performed user action may be considered more effective than the ad on which the users did not perform any user action. Accordingly, the effectiveness of an ad may be measured using various actions performed by the user on the ad.

The effectiveness metric can help the advertisers in creating ad creatives that are more effective and thus, help in obtaining an improved ROI. In an embodiment, the effectiveness of an ad may be measured using an engagement rate of the ad, which summarizes users' overall responsiveness to an ad creative.

Assume, U denotes a set of unique users to whom ad creative c was delivered, and Vᵤ denotes the set of ad impressions that received a response by a user u, where uεU. Assume that each ad impression v, such that vεVᵤ, is viewable (as determined by process 500). Further, assume that A denotes a complete set of user response types, such as rewinds, altering sound, mouseover, clicks, saving the ad, forwarding the ad, sharing the ad, etc. A response score Sₐ, where 0<Sₐ (u,v)≦1 of action aεA, indicates a degree to which user u performed action a on an ad impression v.

Some example user actions and their response scores, (a, Sₐ) for a user u on an ad impression v of an ad creative c include the following:
Mouseover user action
   Sₐ(u, v)=1 If the user pointed a cursor of a pointing device, such as a mouse, over the ad impression for more than t seconds. Time t, is a configurable pre-defined value (for example, 3 seconds).
   Sₐ(u, v)=0, if the above condition is not satisfied.
Altering sound user action
   Sₐ(u,v)=1 If the user turned the volume on or increased the volume on an ad impression.
   Sₐ(u, v)=0 if the above condition is not satisfied.
Rewind user action:
   Sₐ(u,v)=1 If the user rewound the ad impression, in part or full, and watched part of the ad creative more than once,
   Sₐ(u,v)=0 if the above condition is not satisfied.

In an embodiment, the engagement rate of the ad creative may be determined using the following formula:

$$Engagement Rate = \frac{{\sum }_{u ∈ U} {\sum }_{v ∈ Vu} {\sum }_{a ∈ A} {w}_{a} * {S}_{a} ( u , v ) / \vert {V}_{u} \vert}{\vert U \vert}$$

where wₐ is a weight of user action a, and ρaεA wₐ=1.

In an embodiment, each user action can be given an equal weight by having wₐ=1/|A|.

The engagement rate metric measures an effectiveness of the ad creative as a ratio of a number of responsive users to a total number of users to whom the ad creative was served. In other embodiments, the engagement rate may be measure using other formulas. In addition to the ad creative, the engagement rate can be used to determine effectiveness of other online content, such as web pages, videos, audios, etc.

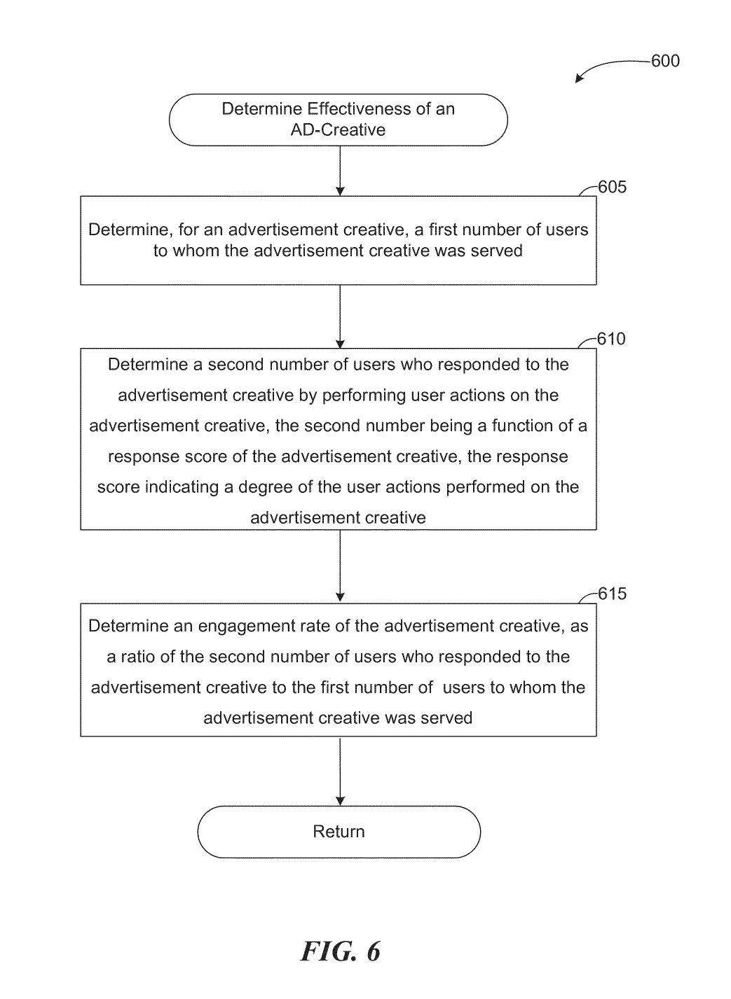

FIG. 6 is a flow diagram of a process 600 for measuring effectiveness of an ad creative, according to an embodiment of the disclosed technique. The process 600 may be executed in a system such as system 400 of FIG. 4. At step 605, SSP determines a first number of users to whom the ad creative is served. In an embodiment, the first number of users may be measured as a total number ad impressions served. At step 610, the SSP determines a second number of users who responded to the ad creative by performing user action on the ad impression. At step 615, an engagement rate of the ad creative is determined as a ratio of the second number of users who responded to the ad to a first number of users to whom the ad creative was served. The engagement rate provides the effectiveness the ad creative.

Referring back to step 610, the second number of users is determined as a function of a response score of an ad creative. The response score indicates a degree of the user actions performed on the ad impressions of the ad creative. The response score is determined for each type of user action. In another embodiment, the second number of users may be measured as a function of a number of ad impressions on which users performed user actions.

### Architecture of Platform Server

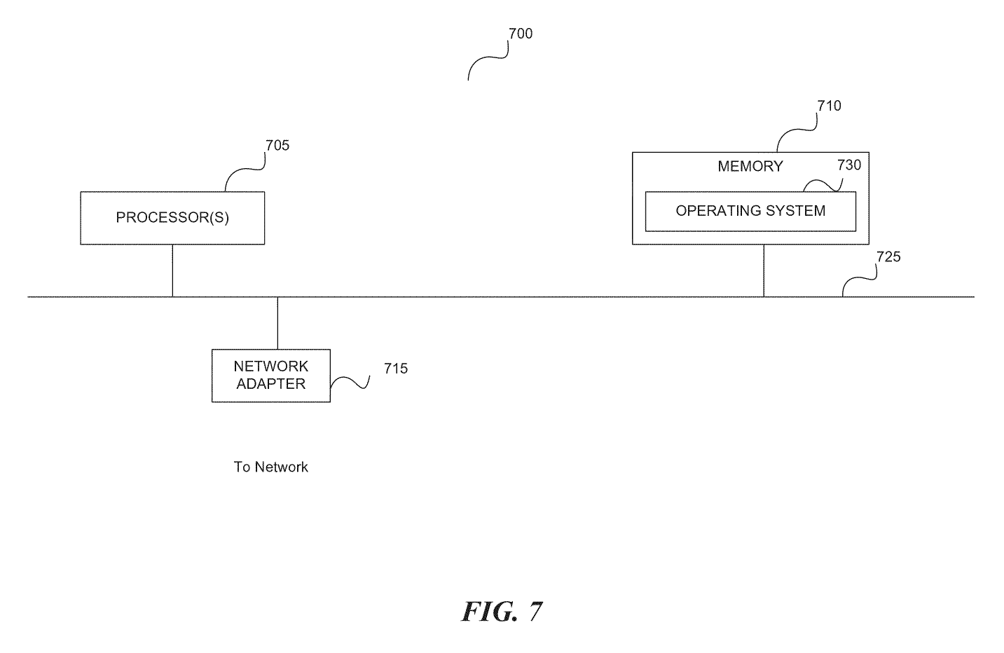

FIG. 7 is a high-level block diagram showing an example of the architecture for a computer system 700 that can be utilized to implement, for example, a platform server (e.g., 114 from FIG. 1), a web server (e.g., 125 from FIG. 1), or any other computing device identified in the above disclosure. The computer system 700 includes one or more processors 705 and memory 710 connected via an interconnect 725. The interconnect 725 is an abstraction that represents any one or more separate physical buses, point to point connections, or both connected by appropriate bridges, adapters, or controllers. The interconnect 725, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 694 bus, sometimes referred to as “Firewire.”

The processor(s) 705 may include central processing units (CPUs) to control the overall operation of, for example, the host computer. In certain embodiments, the processor(s) 705 accomplish this by executing software or firmware stored in memory 710. The processor(s) 705 may be, or may include, one or more programmable general-purpose or special-purpose microprocessors, digital signal processors, programmable controllers, application specific integrated circuits (ASICs), programmable logic devices (PLDs), or the like, or a combination of such devices.

The memory 710 is or includes the main memory of the computer system 700. The memory 710 represents any form of random access memory (RAM), read-only memory (ROM), flash memory (as discussed above), or the like, or a combination of such devices. In use, the memory 710 may contain, among other things, a set of machine instructions which, when executed by processor 705, causes the processor 705 to perform operations to implement embodiments of the present invention.

Also connected to the processor(s) 705 through the interconnect 725 is a network adapter 715. The network adapter 715 provides the computer system 700 with the ability to communicate with remote devices, such as the storage clients, and/or other storage servers, and may be, for example, an Ethernet adapter or Fiber Channel adapter.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the invention.

What is claimed is:

1. A method of receiving and processing a plurality of bids for an advertisement (ad) spot available through an auction, the method comprising:
determining, by a platform server having a processor, whether a pre-defined portion of the ad spot is visible;
responsive to a determination that the pre-defined portion was visible, determining, by the platform server, whether the pre-defined portion was visible for a pre-defined duration; and
responsive to a determination that the pre-defined portion was visible for a pre-defined duration, presenting, by the platform server, the ad spot to the auction.

2. The method of claim 1, wherein determining whether the pre-defined portion of the ad spot was visible for the pre-defined duration includes:
embedding a tag in a web page containing the ad spot, where in the tag sends data regarding visibility of the ad spot and the duration of the visibility of the ad spot to the platform server.

3. The method of claim 2, wherein determining whether the pre-defined portion of the ad spot was visible for the pre-defined duration includes:
receiving, by the tag embedded on the web page being accessed by a user and at the platform server, data regarding visibility of the ad spot and the duration of the visibility of the ad spot.

4. The method of claim 1, wherein presenting the ad spot to the auction includes:
sending a request for bid to bidders, the request including a pre-defined response time indicating a time within which the bidders have to respond to the request.

5. The method of claim 1, further comprising:
receiving, by the platform server and from a plurality of bidders participating in the auction, the bids for displaying one or more advertisements in the ad spot;
determining, by the platform server, a winning bid based on a predefined criteria; and
notifying, by the platform server, a bidder corresponding to the winning bid of the win.

6. The method of claim 5, further comprising:
serving the one or more advertisements from a winning bidder in the ad spot.

7. The method of claim 5, wherein receiving the bids includes
receiving the bids in a pre-defined response time.

8. A method of measuring an effectiveness of an advertisement, the method comprising:
determining, by a platform server having a processor and for an advertisement creative, a first number of users to whom the advertisement creative was served;
determining, by the platform server, a second number of users who responded to the advertisement creative by performing user actions on the advertisement creative, the second number being a function of a response score of the advertisement creative, the response score indicating a degree of the user actions performed on the advertisement creative; and
determining, by the platform server, an engagement rate of the advertisement creative, as a ratio of the second number of users who responded to the advertisement creative to the first number of users to whom the advertisement creative was served.

9. The method of claim 8, wherein the second number of users is determined as a function of number of ad impressions which received a response from the users.

10. The method of claim 8, wherein the first number of users is determined as a function of number of ad impressions served to the users.

11. The method of claim 8, wherein the user actions include at least one of (a) rewinding the ad impression, (b) altering audio volume of the advertisement impression, (c) hovering a cursor of a pointing device over the advertisement impression, (d) saving the advertisement impression on a storage unit by the user, (e) forwarding the advertisement to another user via email, or (f) sharing the advertisement with other users in a social network.

12. The method of claim 11, wherein each of the user actions has an associated weight.

13. A system, comprising:
at least one memory storing computer-executable instructions; and
at least one processor configured to access the at least one memory and execute the computer-executable instructions to perform a set of acts, the acts including:
determining, by a platform server having a processor, whether a pre-defined portion of an ad spot is visible;
responsive to a determination that the pre-defined portion was visible, determining, by the platform server, whether the pre-defined portion was visible for a pre-defined duration; and
responsive to a determination that the pre-defined portion was visible for a pre-defined duration, presenting, by the platform server, the ad spot to the auction.
